(19) United States
(12) Patent Application Publication
(10) Pub. No.: US 2026/0054770 A1
(43) Pub. Date: Feb. 26, 2026

(54) ELECTRIC POWER STEERING DEVICE, AND STEERING CONTROL SYSTEM AND STEERING CONTROL METHOD HAVING THE SAME

(71) Applicant: HL MANDO CORPORATION, Pyeongtaek-si (KR)

(72) Inventors: Su Min LEE, Pyeongtaek-si (KR); Kyu Yeong JE, Pyeongtaek-si (KR)

(21) Appl. No.: 19/057,328

(22) Filed: Feb. 19, 2025

(30) Foreign Application Priority Data
Aug. 26, 2024 (KR) 10-2024-0114632

(51) Int. Cl. B62D 5/04

(52) U.S. Cl. CPC B62D 5/046; B62D 5/0484

(57) ABSTRACT

The present embodiments relate to an electric power steering device, and a steering control system and method. More particularly, there may provide an electric power steering device, and a steering control system and method capable of allowing two independent electronic control units to continuously share information by receiving power from the other power supply in the event that power supply to one of the two independent electronic control units is interrupted or a failure occurs in the power supply connected to one of the two independent electronic control units.

### CROSS REFERENCE TO RELATED APPLICATION

This application claims priority from Korean Patent Application No. 10-2024-0114632, filed on Aug. 26, 2024, which is hereby incorporated by reference for all purposes as if fully set forth herein.

### TECHNICAL FIELD

An embodiment of the present disclosure relates to an electric power steering device, and a steering control system and method capable of allowing two independent electronic control units to continuously share information by receiving power from the other inverter in the event that power supply to one of the two independent electronic control units is interrupted or a failure occurs in the power supply connected to one of the two independent electronic control units.

### BACKGROUND

In general, an electric power steering device of a vehicle refers to a device capable of changing a steering angle of a wheel based on a steering force (or rotational force) applied to a steering wheel by a driver.

Recently, the electric power steering device may have a redundant structure using two independent power supplies and two independent electronic control units (ECUs) to control two independent actuators, respectively.

That is, the electric power steering device may be designed so that even if one of the electronic control units has a problem, the other electronic control unit can operate normally.

In this case, if a failure occurs in one of the two power supplies, the electronic control unit connected to the other power supply can operate the actuator to continue steering.

However, if steering is continuously performed by operating one actuator, there is a problem that reliability and stability are lowered due to output loss.

### SUMMARY

Embodiments of the present disclosure may provide an electric power steering device, and a steering control system and method capable of allowing two independent electronic control units to continuously share information by receiving power from the other inverter in the event that power supply to one of the two independent electronic control units is interrupted or a failure occurs in the power supply unit connected to one of the two independent electronic control units.

In accordance with an aspect of the present disclosure, there may be provided an electric power steering device including a first electronic control unit configured to receive a first output voltage of a first power supply, convert the first output voltage into first pulses of a constant frequency to output a first driving voltage to a first steering motor, and generate and output a first operating voltage lower than the first output voltage of the first power supply; a second electronic control unit configured to receive a second output voltage of a second power supply, converts the second output voltage into second pulses of a constant frequency to output a second driving voltage to a second steering motor, and generate and output a second operating voltage lower than the second output voltage of the second power supply; and an auxiliary power generator configured to: in response to power supply to the first electronic control unit being interrupted due to a failure in the first power supply, receive the second driving voltage generate a first auxiliary voltage, and supply the first auxiliary voltage to the first electronic control unit whose power supply is interrupted, and in response to power supply to the second electronic control unit being interrupted due to a failure in the second power supply, receive the first driving voltage to generate a second auxiliary voltage, and supply the second auxiliary voltage to the second electronic control unit whose power supply is interrupted.

In accordance with another aspect of the present disclosure, there may be provided a steering control system including a steering angle setter configured to set a steering angle of a vehicle based on a driving path set by a driving path setter; and an electric steering device configured to assist an operating force of a steering wheel of the vehicle or enable steering based on the steering angle set by the steering angle setter, wherein the electric steering device is configured to: in response to power supply to a first electronic control unit being interrupted due to a failure in a first power supply, receive a second driving voltage generated based on a second power supply to generate a first auxiliary voltage, and supply the first auxiliary voltage to the first electronic control unit whose power supply is interrupted, and in response to power supply to a second electronic control unit being interrupted due to a failure in the second power supply, receive a first driving voltage generated based on the first power supply to generate a second auxiliary voltage, and supply the second auxiliary voltage to the second electronic control unit whose power supply is interrupted.

In accordance with another aspect of the present disclosure, there may be provided a steering control method including: by a first electronic control unit, receiving a first output voltage of a first power supply, converting the first output voltage into first pulses of a constant frequency for outputting a first driving voltage to a first steering motor, and generating and outputting a first operating voltage lower than the first output voltage of the first power supply; by a second electronic control unit, receiving a second output voltage of a second power supply, converting the second output voltage into second pulses of a constant frequency for outputting a second driving voltage to a second steering motor, and generating and outputting a second operating voltage lower than the second output voltage of the second power supply; and by an auxiliary power generator, in response to power supply to the first electronic control unit being interrupted due to a failure in the first power supply, receiving the second driving voltage to generate a first auxiliary voltage, and supplying the first auxiliary voltage to the first electronic control unit whose power supply is interrupted, and in response to power supply to the second electronic control unit being interrupted due to a failure in the second power supply, receiving the first driving voltage to generate a second auxiliary voltage, and supplying the second auxiliary voltage to the second electronic control unit whose power supply is interrupted.

According to embodiments of the present disclosure, it is possible to provide an electric power steering device, and a steering control system and method capable of allowing two independent electronic control units to continuously share information by receiving power from the other power supply in the event that power supply to one of the two independent electronic control units is interrupted or a failure occurs in the power supply connected to one of the two independent electronic control units.

### BRIEF DESCRIPTION OF THE DRAWINGS

FIG. 1 is a block diagram schematically illustrating a vehicle equipped with a steering control system according to the present embodiment.

FIG. 2 illustrates an electric steering device according to the present embodiment.

FIG. 3 illustrates an electric steering device according to one embodiment.

FIG. 4 is a circuit diagram illustrating an electric steering device according to one embodiment.

FIG. 5 is a block diagram illustrating an electric steering device according to another embodiment.

FIG. 6 is a circuit diagram illustrating an electric steering device according to another embodiment.

FIG. 7 is a flowchart illustrating a steering control method according to the present embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

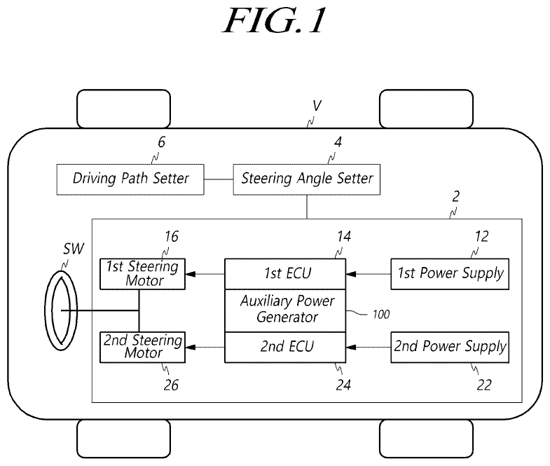

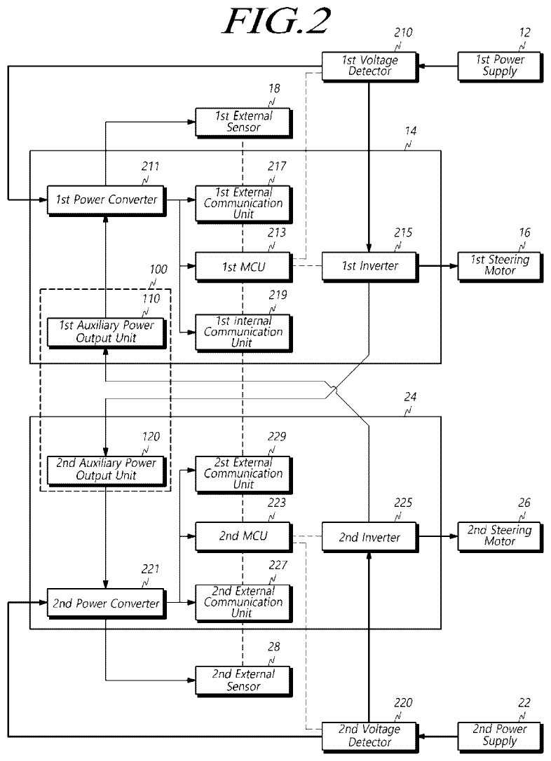

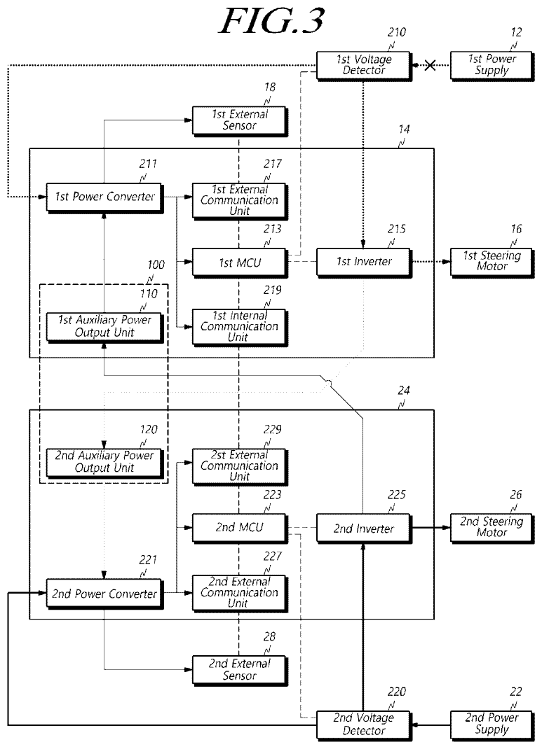

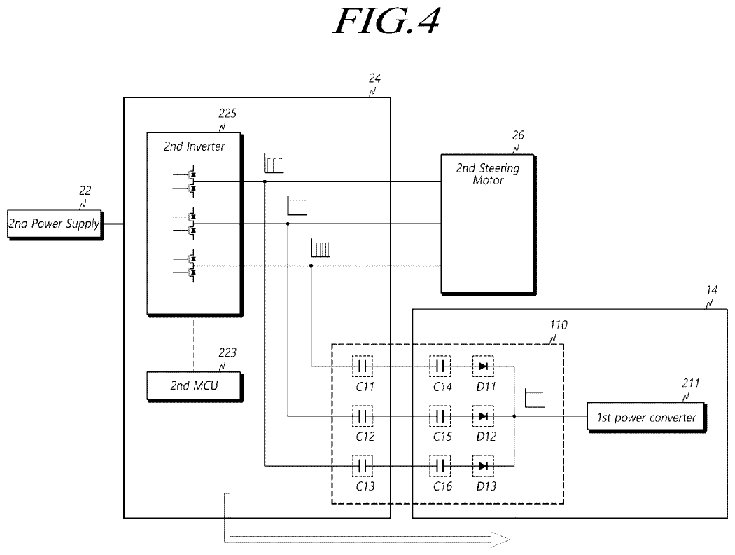

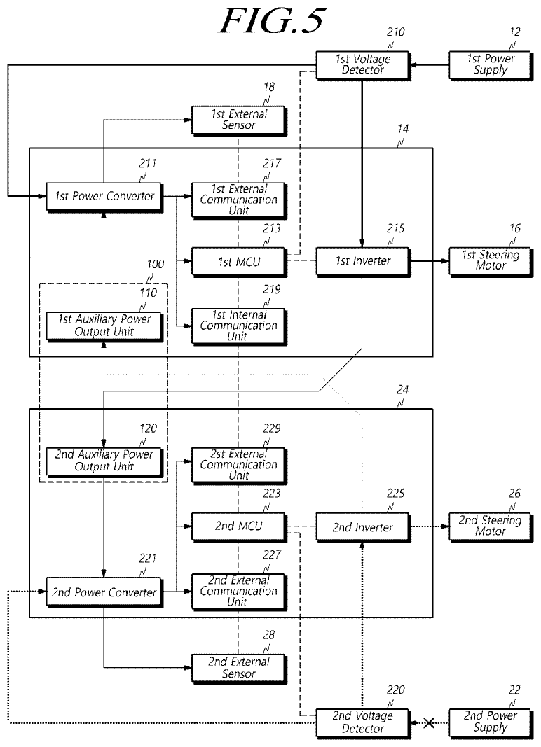

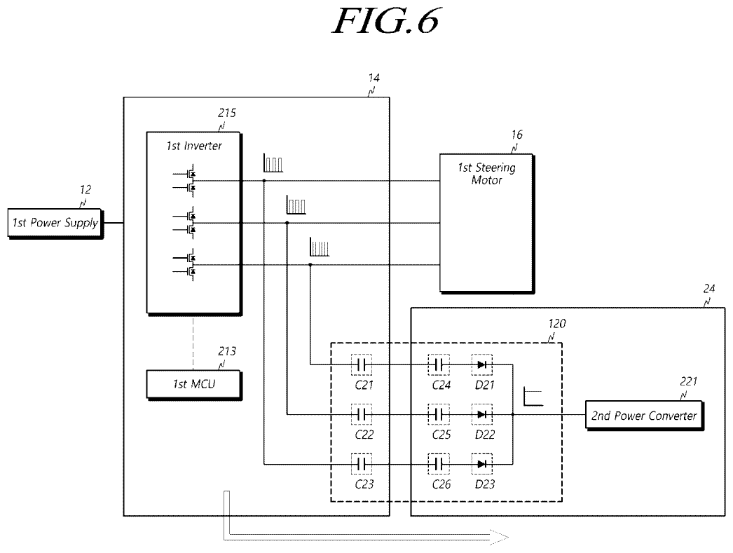

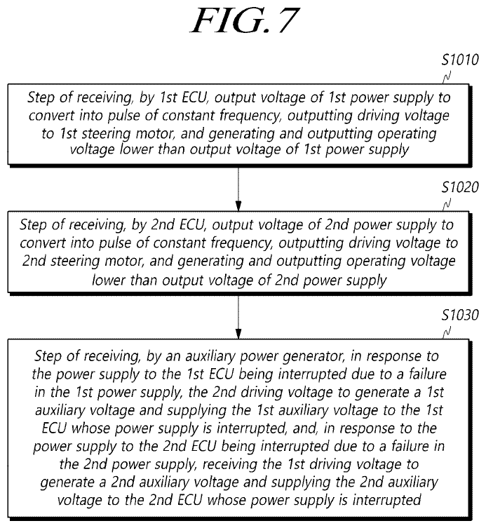

FIG. 1 is a block diagram schematically illustrating a vehicle equipped with a steering control system according to the present embodiment, FIG. 2 illustrates an electric steering device according to the present embodiment, FIG. 3 illustrates an electric steering device according to one embodiment, FIG. 4 is a circuit diagram illustrating an electric steering device according to one embodiment, FIG. 5 is a block diagram illustrating an electric steering device according to another embodiment, FIG. 6 is a circuit diagram illustrating an electric steering device according to another embodiment, and FIG. 7 is a flowchart illustrating a steering control method according to the present embodiment.

A steering device of the vehicle (V) may include an electric power steering (EPS) device which assists the operating power of a steering wheel (SW) by using an electric motor such as a motor to provide convenience in driving operation, and a steer-by-wire (SBW) type steering device which enables steering of the vehicle (V) by using an electric motor such as a motor.

An electric steering device or an electric power steering device of the present embodiment may be applied to a column-type electric steering device, a rack-type electric steering device, or a steer-by-wire type steering device.

Referring to FIG. 1, the steering control system may be a system which electronically controls the steering of the vehicle (V) by using an electric steering device 1, and may perform functions such as automatic steering, lane keeping, and parking assistance of the vehicle (V) by combining with an autonomous driving system.

The steering control system of the present embodiment may include a steering angle setter 4 which sets a steering angle of the vehicle (V) based on a driving path set by a driving path setter 6, and an electric steering device 1 which assists the operating force of the steering wheel (SW) of the vehicle or enables steering based on the steering angle set by the steering angle setter 4.

More specifically, the driving path setter 6 may set a driving path by considering the current location, destination, traffic conditions, etc., and transmit the set driving path to the steering angle setter 4.

In addition, the steering angle setter 4 may set the steering angle of the vehicle (V) based on the driving path set by the driving path setter 6, and may determine a steering angle suitable for the driving situation and transmit the determined steering angle to the electric steering device 1.

In addition, the electric steering device 1 may assist the operating force of the steering wheel (SW) or enable steering based on the steering angle received from the steering angle setter 4.

In this case, the electric steering device 1 may assist the driver's input or control the vehicle (V) completely autonomously.

Hereinafter, the present embodiment describes the structure of an electric steering device 1 that assists the driver's input as an example, but is not limited thereto, and may be applied to all types of steering devices.

The electric steering device 1 may determine a target rack position for providing steering assistance power based on steering information of an external sensor including a steering angle sensor, a torque sensor, and a speed sensor in an electronic control unit so that the driving direction of the vehicle (V) can be easily changed with less force by assisting the operating force of the steering wheel (SW), and outputs a target current corresponding to the target rack position to a steering motor.

Here, the electric steering device 1 may move a rack bar left and right through a pinion gear connected to the output end of a steering shaft and a rack gear as the steering shaft of a steering column rotates by the rotation of the steering motor.

Accordingly, the electric steering device 1 may smoothly drive the vehicle (V) in a desired direction by steering the wheels connected to both ends of the rack bar to the left or right by the rotation of the steering motor for assisting the operating force of the steering wheel (SW) or enabling steering.

The electric steering device 1 of the present embodiment may have a redundant structure which uses two independent power supply and two independent electronic control units to control two independent steering motors, respectively. The electric steering device 1 of the present embodiment may include a first power supply 12, a first electronic control unit 14, a first steering motor 16, a first external sensor 18, a second power supply 22, a second electronic control unit 24, a second steering motor 26, a second external sensor 28, and an auxiliary power generator 100.

The first power supply or the second power supply may include a direct current (DC) voltage generator or an alternating current (AC) voltage generator, and may supply a stable voltage by removing voltage ripple or noise through a filter.

In this embodiment, the first power supply 12 and the second power supply 22 may include a battery, and the first power supply 12 may supply a DC voltage to the first electronic control unit 14, and the second power supply 22 may supply a DC voltage to the second electronic control unit 24.

The electronic control unit ECU (sometimes referred to as “electronic control circuit”) may be implemented with hardware and software including a controller (e.g., micro controller unit; MCU), an inverter, a printed circuit board (PCB), and the like.

The electronic control unit may be supplied with power from the power supply and perform a function of generating and supplying a target current to be supplied to each winding of the steering motor using an inverter.

The inverter may generate a three-phase power with three phases which are 120 degrees apart from each other, and may supply the generated AC power to each phase of the steering motor, which is composed of three coils (e.g., U phase, V phase, W phase).

Here, the steering motor included in the electric steering device 1 may be a dual winding EPS motor including a first steering motor 16 and a second steering motor 26 inside, but is not limited thereto.

Specifically, the first electronic control unit 14 may receive power from the first power supply 12 and supply power to the first steering motor 16 and the first external sensor 18.

That is, the first electronic control unit 14 may receive a first output voltage of the first power supply 12, convert the first output voltage into first pulses of a certain frequency to output a first driving voltage to the first steering motor 16, and generate a first operating voltage lower than the first output voltage of the first power supply 12 and outputs the first operating voltage to the first external sensor 18.

The first electronic control unit 14 may electronically control the operation of the first steering motor 16 in response to the signals of the first external sensor 18.

In this case, the first electronic control unit 14 may include a first voltage detector 210 which monitors the first output voltage of the first power supply 12 to detect whether there is an abnormality in the first power supply 12.

The first voltage detector 210 may monitor the first output voltage of the first power supply 12 to detect whether there is an abnormality in a connector connection status of the first power supply 12, and may provide the status information of the first power supply 12 to a first micro controller unit (MCU) 213 or a second micro controller unit (MCU) 223, or output the status information of the first power supply 12 through a display unit.

In addition, the second electronic control unit 24 may receive power from the second power supply 22 and supply power to the second steering motor 26 and the second external sensor 28.

That is, the second electronic control unit 24 may receive a second output voltage of the second power supply 22, converts the second output voltage into second pulses of a certain frequency to output a second driving voltage to the second steering motor 26, and generate a second operating voltage lower than the second output voltage of the second power supply 22 and outputs the second operating voltage to the second external sensor 28.

The second electronic control unit 24 may electronically control the operation of the second steering motor 26 in response to the signals of the second external sensor 28.

In this case, the second electronic control unit 24 may include a second voltage detector 220 for monitoring the second output voltage of the second power supply 22 and detecting whether there is an abnormality in the second power supply 22.

The second voltage detector 220 may monitor the second output voltage of the second power supply 22 to detect abnormalities such as the connector connection status of the second power supply 22, and may provide the status information of the second power supply 22 to the second micro controller unit (MCU) 223 or the first micro controller unit (MCU) 213, or output the status information through the display unit.

The external sensor may include a torque sensor for measuring a torsional force applied to a rotating component such as a steering wheel SW of the vehicle V, an angle sensor for measuring the position or rotation angle of the rotating component such as the steering wheel SW, and a speed sensor.

The first external sensor 18 may be connected to the first electronic control unit 14, and may collect the steering status information and environmental information of the vehicle (V) and provide the information to the first electronic control unit 14.

In addition, the second external sensor 28 may be connected to the second electronic control unit 24, and may collect steering status information and environmental information of the vehicle V and provide the information to the second electronic control unit 24.

In accordance with an aspect of the present disclosure, an electric power steering device according to embodiments of the present disclosure may include a first electronic control unit 14 for receiving a first output voltage of a first power supply 12, converting the first output voltage into first pulses of a constant frequency to outputting a first driving voltage to a first steering motor 16, and generating and outputting a first operating voltage lower than the first output voltage of the first power supply 12; a second electronic control unit 24 for receiving a second output voltage of a second power supply 22, converting the second output voltage into second pulses of a constant frequency to outputting a second driving voltage to a second steering motor 26, and generating and outputting a second operating voltage lower than the second output voltage of the second power supply 22; and an auxiliary power generator 100 for, in response to power supply to the first electronic control unit 14 being interrupted due to a failure in the first power supply 12, receiving the second driving voltage to generating a first auxiliary voltage, and supplying the first auxiliary voltage to the first electronic control unit 14 whose power supply is interrupted, and in response to power supply to the second electronic control unit 24 being interrupted due to a failure in the second power supply 22, receive the first driving voltage to generate a second auxiliary voltage, and supply the second auxiliary voltage to the second electronic control unit 24 whose power supply is interrupted.

Referring to FIG. 2, the first electronic control unit 14 may receive the first output voltage of the first power supply 12, convert the first output voltage of the first power supply 12 into first pulses of a constant frequency to output a first driving voltage to the first steering motor 16, and generate and output a first operating voltage lower than the first output voltage of the first power supply 12.

Here, the first electronic control unit 14 may include a first power for generating and outputting a first operating voltage lower than the first output voltage of the first power supply 12; a first micro controller unit (MCU) 213 for receiving and processing data from the first external sensor 18 and generating a control command; and a first inverter 215 for receiving the first output voltage of the first power supply 12 to convert into first pulses of a constant frequency, and outputting a first driving voltage to the first steering motor 16.

In addition, the second electronic control unit 24 may receive the second output voltage of the second power supply 22, convert the second output voltage of the second power supply into second pulses of a constant frequency, output a second driving voltage to the second steering motor 26, and generate and output a second operating voltage lower than the second output voltage of the second power supply 22.

Here, the second electronic control unit 24 may include a second power converter 221 which generates and outputs a second operating voltage lower than the second output voltage of the second power supply 22; a second micro controller unit (MCU) 223 which receives and processes data from the second external sensor 28 and generates a control command; and a second inverter 225 which receives the second output voltage of the second power supply 22, converts the second output voltage into second pulses of a constant frequency, and outputs a second driving voltage to the second steering motor 26.

In addition, if a failure occurs in either the first power supply 12 or the second power supply 22 and the power supply is interrupted, the auxiliary power generator 100 may receive another driving voltage to generate an auxiliary voltage and supply the auxiliary voltage to the first electronic control unit 14 or the second electronic control unit 24 whose power supply is interrupted.

That is, if a failure occurs in the first power supply 12 and the power supply to the first electronic control unit 14 is interrupted, the auxiliary power generator 100 may receive the second driving voltage (e.g., PWM inverter switching voltage) of the second electronic control unit 24 to generate a first auxiliary voltage and supply the first auxiliary voltage to the first electronic control unit 14 (e.g., ECU regulator) whose power supply is interrupted.

Meanwhile, if a failure occurs in the second power supply 22 and power supply to the second electronic control unit 24 is interrupted, the auxiliary power generator 100 may receive the first driving voltage (e.g., PWM inverter switching voltage) of the first electronic control unit 14 to generate a second auxiliary voltage and supply the second auxiliary voltage to the second electronic control unit 24 (e.g., ECU regulator) whose power supply is interrupted.

For example, the second electronic control unit 24 may include a second inverter 225 which receives the second output voltage of the second power supply 22 and converts it into second pulses of a constant frequency to output a second driving voltage to the second steering motor 26. The first electronic control unit 14 may include a first power converter 211 which generates and outputs a first operating voltage lower than the first output voltage of the first power supply 12 In addition, the auxiliary power generator 100 may include a first auxiliary power output unit 110 which receives the second driving voltage output from the second inverter 225 to generate a first auxiliary voltage and supplies the first auxiliary voltage to the first power converter 211 if the power supply to the first electronic control unit 14 is interrupted or cut off.

Referring to FIG. 3, if power supply to the first electronic control unit 14 is interrupted, the first power converter 211 may receive the first auxiliary voltage output from the first auxiliary power output unit 110, convert the frequency of the first auxiliary voltage, and generate and output a first operating voltage of 5 V or 3.3 V to at least one of the first micro controller unit (MCU) 213, a first external communication unit 217, and a first internal communication unit 219 of the first electronic control unit.

Here, the first micro controller unit (MCU) 213 may share information with the second micro controller unit (MCU) 223 of the second electronic control unit through the first internal communication unit 219 and the second internal communication unit 229 if the first auxiliary voltage is supplied to the first power converter 211.

In this case, the first micro controller unit (MCU) 213 may check a connector connection status of the first power supply 12 through the first voltage detector 210, and if the connector connection status of the first power supply 12 is abnormal, the first micro controller unit (MCU) 213 may share information with the second micro controller unit (MCU) 223 to prevent malfunction of a boost assist.

In addition, the first power converter 211 may receive the first auxiliary voltage output from the first auxiliary power output unit 110 if the power supply to the first electronic control unit 14 is interrupted, convert the frequency, generate and output a first operating voltage of 5 V to the first external sensor 18.

Here, the first micro controller unit (MCU) 213 may transmit and receive signals with the first external sensor 18 through the first external communication unit 217 if the first auxiliary voltage is supplied to the first power converter 211.

In this way, if the power supply to the first electronic control unit 14 is interrupted or the first power supply 12 has a failure, the electric power steering device of the present disclosure may receive power from the first auxiliary power output unit 110 so that the first electronic control unit 14 may continuously share information with the second electronic control unit 24 and perform the steering operation.

The first internal communication unit 219 may be a private communication line which is not connected to an external node and through which only the first micro controller unit (MCU) 213 and the second micro controller unit (MCU) 223 can transmit and receive data.

In addition, the first external communication unit 217 may be a public communication line or a vehicle communication line which is connected to an external node so that the first micro controller unit (MCU) 213 and the second micro controller unit (MCU) 223 can receive sensing information detected by each sensor from the first external sensor 18 mounted on the vehicle (V).

The first auxiliary power output unit 110 may include a voltage charger, which is located between the second inverter 225 and the first power converter 211, and is connected in series with one or more of each phase of the second inverter 225 which receives the second output voltage of the second power supply 22 and converts the second output voltage into a three-phase power; and a backflow prevention unit, which is located between the second inverter 225 and the first power converter 211, and prevents backflow of the first auxiliary voltage back to the second inverter 225.

Referring to FIG. 4, the first auxiliary power output unit 110 may be located between the second inverter 225 and the first power converter 211, and may convert the three-phase power (e.g., U phase, V phase, W phase) output from the second inverter 225 into a constant voltage and supply to the first power converter 211.

Here, the voltage charger may be located between the second inverter 225 and the first power converter 211, and may be connected in series with one or more of each phase of the second inverter 225.

For example, the voltage charger may include a capacitor C11 and C14 connected in series to one of the phases, a capacitor C12 and C15 connected in series to another of the phases, and a capacitor C13 and C16 connected in series to another of the phases.

The capacitor may be used to remove ripple or noise in the auxiliary power generator 100.

In particular, the capacitor may play a role in filtering out AC components in the auxiliary power generator 100, maintaining a constant DC voltage, and storing and releasing electric energy for a short period of time.

The backflow prevention unit may be located between the second inverter 225 and the first power converter 211, and may prevent backflow of the first auxiliary voltage back to the second inverter 225.

For example, the backflow prevention unit may include a diode D11 connected in series with one of the phases, a diode D12 connected in series with another of the phases, and a diode D13 connected in series with another of the phases.

As another example, the first electronic control unit 14 includes a first inverter 215 which receives the first output voltage of the first power supply 12, converts it into first pulses of a constant frequency, and outputs a first driving voltage to the first steering motor 16. The second electronic control unit 24 may include a second power converter 221 for generating and outputting a second operating voltage lower than the second output voltage of the second power supply 22. In addition, the auxiliary power generator 100 may include a second auxiliary power output unit 120 which receives the first driving voltage output from the first inverter 215 to generate a second auxiliary voltage and supplies the second auxiliary voltage to the second power converter 221 if the power supply to the second electronic control unit 24 is interrupted or cut off.

Referring to FIG. 5, if the power supply to the second electronic control unit 24 is interrupted, the second power converter 221 may receive the second auxiliary voltage output from the second auxiliary power output unit 120, convert the frequency of the second auxiliary voltage, and generate and output a second operating voltage of 5 V or 3.3 V to at least one of the second micro controller unit (MCU) 223, a second external communication unit 227, and a second internal communication unit 229 of the second electronic control unit.

Here, the second micro controller unit (MCU) 223 may share information with the first micro controller unit (MCU) 213 of the first electronic control unit through the second internal communication unit 229 and the first internal communication unit 219 if the second auxiliary voltage is supplied to the second power converter 221.

In this case, the second micro controller unit (MCU) 223 may check a connector connection status of the second power supply 22 through a second voltage detector 220, and if the connector connection status of the second power supply 22 is abnormal or poor, the second micro controller unit (MCU) 223 may share information with the first micro controller unit (MCU) 213 to prevent malfunction of a boost assist.

In addition, if the power supply to the second electronic control unit 24 is interrupted, the second power converter 221 may receive the second auxiliary voltage output from the second auxiliary power output unit 120, convert the frequency, generate a second operating voltage of 5 V, and output it to the second external sensor 28.

Here, the second micro controller unit (MCU) 223 may transmit and receive signals with the second external sensor 28 through the second external communication unit 227 if the second auxiliary voltage is supplied to the second power converter 221.

In this way, the electric power steering device of the embodiment may receive power from the second auxiliary power output unit 120 if the power supply to the second electronic control unit 24 is interrupted or a failure occurs in the second power supply 22, so that the second electronic control unit 24 may continuously share information with the first electronic control unit 14 and perform the steering operation.

The second internal communication unit 229 may be a private communication line which is not connected to an external node and through which only the second micro controller unit (MCU) 223 and the first micro controller unit (MCU) 213 can transmit and receive data.

In addition, the second external communication unit 227 may be a public (vehicle) communication line connected to an external node so that the second micro controller unit (MCU) 223 and the first micro controller unit (MCU) 213 can receive sensing information detected by each sensor from the second external sensor 28 mounted on the vehicle (V).

The second auxiliary power output unit 120 may include a voltage charger located between the first inverter 215 and the second power converter 221, and connected in series to each phase of the first inverter 215 which receives the first output voltage of the first power supply 12 and converts the first output voltage into a three-phase power; and a backflow prevention unit located between the first inverter 215 and the second power converter 221 and prevents backflow of the second auxiliary voltage back to the first inverter 215.

Referring to FIG. 6, the second auxiliary power output unit 120 may be located between the first inverter 215 and the second power converter 221, and may convert the three-phase power (e.g., U phase, V phase, W phase) output from the first inverter 215 into a constant voltage, and supply it to the second power converter 221.

Here, the voltage charger may be located between the first inverter 215 and the second power converter 221, and may be connected in series with one or more of each phase of the first inverter 215.

For example, the voltage charger may include a capacitor C21 and C24 connected in series to one of the phases, a capacitor C22 and C25 connected in series to another of the phases, and a capacitor C23 and C26 connected in series to another of the phases.

The capacitor may be used to remove ripple or noise from the auxiliary power generator 100.

In particular, the capacitor may play a role in filtering out AC components from the auxiliary power generator 100, maintaining a constant DC voltage, and storing and releasing electric energy for a short period of time.

The backflow prevention unit may be located between the first inverter 215 and the second power converter 221, and may prevent the backflow of the second auxiliary voltage back to the first inverter 215.

For example, the backflow prevention unit may include a diode D21 connected in series to one of the phases, a diode D22 connected in series to another of the phases, and a diode D23 connected in series to another of the phases.

In another aspect, the steering control system of the present embodiment may include a steering angle setter 4 which sets a steering angle of the vehicle (V) based on a driving path set by a driving path setter 6; and an electric steering device 1 which assists the operating force of the steering wheel (SW) or enables steering based on the steering angle set by the steering angle setter 4.

In more detail, the driving path setter 6 may set a driving path by considering the current location, destination, traffic conditions, etc., and transmit information on the set driving path to the steering angle setter 4.

In addition, the steering angle setter 4 may set the steering angle of the vehicle (V) based on the driving path set by the driving path setter 6, determine a steering angle suitable for the driving situation, and transmit information on the set steering angle to the electric steering device 1.

In addition, the electric steering device 1 may assist the operating force of the steering wheel SW or enable steering according to the steering angle received from the steering angle setter 4.

In this case, the electric steering device 1 may assist the driver's input or control the vehicle (V) completely autonomously.

The electric steering device 1 may include a first electronic control unit 14 which receives the first output voltage of a first power supply 12, converts the first output voltage into first pulses of a constant frequency to output a first driving voltage to a first steering motor 16, and generates and outputs a first operating voltage lower than the first output voltage of the first power supply 12; a second electronic control unit 24 which receives the second output voltage of a second power supply 22, converts the second output voltage into second pulses of a constant frequency to output a second driving voltage to a second steering motor 26, and generates and outputs a second operating voltage lower than the second output voltage of the second power supply 22; and an auxiliary power generator 100 which, in response to the power supply to the first electronic control unit 14 being interrupted, receives the second driving voltage to generate a first auxiliary voltage and supplies the first auxiliary voltage to the first electronic control unit 14 whose power supply is interrupted and in response to the power supply to the second electronic control unit 24 being interrupted, receives the first driving voltage to generate the second auxiliary voltage, and supplies the second auxiliary voltage to the second electronic control unit 24 whose power supply is interrupted.

For example, the second electronic control unit 24 may include a second inverter 225 which receives the second output voltage of the second power supply 22 and converts it into second pulses of a constant frequency to output a second driving voltage to the second steering motor 26. The first electronic control unit 14 may include a first power converter 211 which generates and outputs a first second operating voltage lower than the output voltage of the first power supply 12. In addition, the auxiliary power generator 100 may include a first auxiliary power output unit 110 which receives the second driving voltage output from the second inverter 225 to generate a first auxiliary voltage and supplies the first auxiliary voltage to the first power converter 211 if the power supply to the first electronic control unit 14 is interrupted.

As another example, the first electronic control unit 14 may include a first inverter 215 which receives the first output voltage of the first power supply 12, converts it into first pulses of a constant frequency, and outputs a first driving voltage to the first steering motor 16. The second electronic control unit 24 may include a second power converter 221 which generates and outputs a second operating voltage lower than the second output voltage of the second power supply 22. In addition, the auxiliary power generator 100 may include a second auxiliary power output unit 120 which receives the first driving voltage output from the first inverter 215 to generate a second auxiliary voltage and supplies the second auxiliary voltage to the second power converter 221 if the power supply to the second electronic control unit 24 is cut off or interrupted.

In another aspect, the steering control method of the present embodiment may include a step (S1010) of receiving, by a first electronic control unit 14, a first output voltage of a first power supply 12, converting the first output voltage into first pulses of a constant frequency for outputting a first driving voltage to a first steering motor 16, and generating and outputting a first operating voltage lower than the first output voltage of the first power supply 12; a step (S1020) of receiving, by a second electronic control unit 24, a second output voltage of a second power supply 22, converting the second output voltage into second pulses of a constant frequency for outputting a second driving voltage to a second steering motor 26, and generating and outputting a second operating voltage lower than the second output voltage of the second power supply 22; and a step (S1030) of receiving, by an auxiliary power generator 100, in response to power supply to the first electronic control unit 14 being interrupted due to a failure in the first power supply 12, receiving the second driving voltage to generate a first auxiliary voltage, and supplying the first auxiliary voltage to the first electronic control unit 14 whose power supply is interrupted, and in response to power supply to the second electronic control unit 24 being interrupted due to a failure in the second power supply 22, receiving the first driving voltage to generate a second auxiliary voltage, and supplying the second auxiliary voltage to the second electronic control unit 24 whose power supply is interrupted.

Referring to FIG. 7, in the embodiment, the steering angle setter 4 may set the steering angle of the vehicle (V) based on the driving path set by the driving path setter 6, and determine the steering angle suitable for the driving situation and transmits information on the steering angle to the electric steering device 1.

In addition, the electric steering device 1 may assist the operating force of the steering wheel (SW) or enable steering according to the steering angle received from the steering angle setter 4.

In this case, the first electronic control unit 14 may receive the first output voltage of the first power supply 12, convert it into first pulses of a certain frequency, output a first driving voltage to the first steering motor 16, and generate and output a first operating voltage lower than the first output voltage of the first power supply 12.

In addition, in an embodiment, the second electronic control unit 24 may receive the second output voltage of the second power supply 22, convert it into second pulses of a certain frequency, output a second driving voltage to the second steering motor 26, and generate and output a second operating voltage lower than the second output voltage of the second power supply 22.

In this embodiment, the first steering motor 16 and the second steering motor 26 may operate simultaneously with 50% output, so that the load applied to each steering motor may be distributed, thereby increasing the operating efficiency of the steering motor and preventing overload.

In this case, if a failure occurs in either the first power supply 12 or the second power supply 22, the electronic control unit connected to the other power supply may operate the steering motor to continue steering with 75% output.

In the present embodiment, if a failure occurs in either the first power supply or the second power supply and the power supply is interrupted, the auxiliary power generator 100 may receive another driving voltage to generate an auxiliary voltage and supply the auxiliary voltage to the first electronic control unit 14 or the second electronic control unit 24 whose power supply is interrupted.

In this way, the steering control method of the present embodiment may improve the driving safety of the vehicle (V) by supplying power from another power supply if the power supply to either of the two independent electronic control units is interrupted or a failure occurs in the power supply connected to either of the two independent electronic control units, thereby allowing the two independent electronic control units to continuously share information and perform the steering operation.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The scope of protection of the present disclosure should be construed based on the following claims, and all technical ideas within the scope of equivalents thereof should be construed as being included within the scope of the present disclosure.

What is claimed is:

1. An electric power steering device, comprising:
a first electronic control unit configured to receive a first output voltage of a first power supply, convert the first output voltage e into first pulses of a constant frequency to output a first driving voltage to a first steering motor, and generate and output a first operating voltage lower than the first output voltage of the first power supply;
a second electronic control unit configured to receive a second output voltage of a second power supply, convert the second output voltage into second pulses of a constant frequency to output a second driving voltage to a second steering motor, and generate and output a second operating voltage lower than the second output voltage of the second power supply; and
an auxiliary power generator configured to:
in response to power supply to the first electronic control unit being interrupted due to a failure in the first power supply, receive the second driving voltage to generate a first auxiliary voltage, and supply the first auxiliary voltage to the first electronic control unit whose power supply is interrupted, and
in response to power supply to the second electronic control unit being interrupted due to a failure in the second power supply, receive the first driving voltage to generate a second auxiliary voltage, and supply the second auxiliary voltage to the second electronic control unit whose power supply is interrupted.

2. The electric power steering device of claim 1, wherein
the second electronic control unit comprises a second inverter configured to receive the second output voltage of the second power supply and convert the second output voltage into the second pulses for outputting the second driving voltage to the second steering motor,
the first electronic control unit comprises a first power converter configured to generate and output the first operating voltage, and
the auxiliary power generator comprises a first auxiliary power output unit configured to receive the second driving voltage output from the second inverter to generate the first auxiliary voltage, and supply the first auxiliary voltage to the first power converter in response to the power supply to the first electronic control unit being interrupted.

3. The electric power steering device of claim 2, wherein, in response to the power supply to the first electronic control unit being interrupted, the first power converter is configured to receive the first auxiliary voltage output from the first auxiliary power output unit, convert a frequency of the first auxiliary voltage to generate the first operating voltage, and output the first operating voltage to at least one of a first micro controller unit (MCU), a first external communication unit, or a first internal communication unit of the first electronic control unit.

4. The electric power steering device of claim 3, wherein, in response to the first auxiliary voltage being supplied to the first power converter, the first MCU is configured to share information with a second MCU of the second electronic control unit through the first internal communication unit.

5. The electric power steering device of claim 3, wherein, in response to the power supply to the first electronic control unit being interrupted, the first power converter is further configured to output the first operating voltage to a first external sensor.

6. The electric power steering device of claim 5, wherein, in response to the first auxiliary voltage being supplied to the first power converter, the first MCU is configured to transmit and receive signals with the first external sensor through the first external communication unit.

7. The electric power steering device of claim 2, wherein
the first auxiliary power output unit comprises a voltage charger located between the second inverter and the first power converter, and connected in series to at least one phase of the second inverter.

8. The electric power steering device of claim 2, wherein the first auxiliary power output unit comprises a backflow prevention unit which is located between the second inverter and the first power converter, and configured to prevent a backflow of the first auxiliary voltage back to the second inverter.

9. The electric power steering device of claim 1, wherein
the first electronic control unit comprises a first inverter configured to receive the first output voltage of the first power supply and convert the first output voltage into the first pulses for outputting the first driving voltage to the first steering motor,
the second electronic control unit comprises a second power converter configured to generate and output the second operating voltage, and
the auxiliary power generator comprises a second auxiliary power output unit configured to receive the first driving voltage output from the first inverter to generate the second auxiliary voltage, and supply the second auxiliary voltage to the second power converter in response to the power supply to the second electronic control unit being interrupted.

10. The electric power steering device of claim 9, wherein, in response to the power supply to the second electronic control unit being interrupted, the second power converter is configured to receive the second auxiliary voltage output from the second auxiliary power output unit, convert a frequency of the second auxiliary voltage to generate the second operating voltage, and output the second operating voltage to at least one of a second micro controller unit (MCU), a second external communication unit, or a second internal communication unit of the second electronic control unit.

11. The electric power steering device of claim 10, wherein, in response to the second auxiliary voltage being supplied to the second power converter, the second MCU is configured to share information with a first MCU of the first electronic control unit through the second internal communication unit.

12. The electric power steering device of claim 10, wherein, in response to the power supply to the second electronic control unit being interrupted, the second power converter is further configured to output the second operating voltage to a second external sensor.

13. The electric power steering device of claim 12, wherein, in response to the second auxiliary voltage being supplied to the second power converter, the second MCU is configured to transmit and receive signals with the second external sensor through the second external communication unit.

14. The electric power steering device of claim 9, wherein
the second auxiliary power output unit comprises a voltage charger located between the first inverter and the second power converter, and connected in series to at least one phase of the first inverter.

15. The electric power steering device of claim 9, wherein the second auxiliary power output unit comprises a backflow prevention unit which is located between the first inverter and the second power converter, and configured to prevent a backflow of the second auxiliary voltage back to the first inverter.

16. A steering control system, comprising:
a steering angle setter configured to set a steering angle of a vehicle based on a driving path set by a driving path setter; and
an electric steering device configured to assist an operating force of a steering wheel of the vehicle or enable steering based on the steering angle set by the steering angle setter,
wherein the electric steering device is configured to:
in response to power supply to a first electronic control unit being interrupted due to a failure in a first power supply, receive a second driving voltage generated based on a second power supply to generate a first auxiliary voltage, and supply the first auxiliary voltage to the first electronic control unit whose power supply is interrupted, and
in response to power supply to a second electronic control unit being interrupted due to a failure in the second power supply, receive a first driving voltage generated based on the first power supply to generate a second auxiliary voltage, and supply the second auxiliary voltage to the second electronic control unit whose power supply is interrupted.

17. The steering control system of claim 16, wherein the electric steering device comprises:
the first electronic control unit configured to receive a first output voltage of the first power supply, convert the first output voltage into first pulses of a constant frequency to output the first driving voltage to a first steering motor, and generate and output a first operating voltage lower than the first output voltage of the first power supply;
the second electronic control unit configured to receive a second output voltage of the second power supply, convert the second output voltage into second pulses of a constant frequency to output the second driving voltage to a second steering motor, and generate and output a second operating voltage lower than the second output voltage of the second power supply; and
an auxiliary power generator configured to:
in response to the power supply to the first electronic control unit being interrupted, receive the second driving voltage to generate the first auxiliary voltage, and supply the first auxiliary voltage to the first electronic control unit whose power supply is interrupted, and
in response to the power supply to the second electronic control unit being interrupted, receive the first driving voltage to generate the second auxiliary voltage, and supply the second auxiliary voltage to the second electronic control unit whose power supply is interrupted.

18. The steering control system of claim 17, wherein
the second electronic control unit comprises a second inverter configured to receive the second output voltage of the second power supply and convert the second output voltage into the second pulses for outputting the second driving voltage to the second steering motor,
the first electronic control unit comprises a first power converter configured to generate and output the first operating voltage, and
the auxiliary power generator comprises a first auxiliary power output unit configured to receive the second driving voltage output from the second inverter to generate the first auxiliary voltage, and supply the first auxiliary voltage to the first power converter in response to the power supply to the first electronic control unit being interrupted.

19. The steering control system of claim 17, wherein
the first electronic control unit comprises a first inverter configured to receive the first output voltage of the first power supply and convert the first output voltage into the first pulses for outputting the first driving voltage to the first steering motor,
the second electronic control unit comprises a second power converter configured to generate and output the second operating voltage, and
the auxiliary power generator comprises a second auxiliary power output unit configured to receive the first driving voltage output from the first inverter to generate the second auxiliary voltage, and supply the second auxiliary voltage to the second power converter in response to the power supply to the second electronic control unit being interrupted.

20. A steering control method, comprising:
by a first electronic control unit,
receiving a first output voltage of a first power supply,
converting the first output voltage into first pulses of a constant frequency for outputting a first driving voltage to a first steering motor, and
generating and outputting a first operating voltage lower than the first output voltage of the first power supply;
by a second electronic control unit,
receiving a second output voltage of a second power supply,
converting the second output voltage into second pulses of a constant frequency for outputting a second driving voltage to a second steering motor, and
generating and outputting a second operating voltage lower than the second output voltage of the second power supply; and
by an auxiliary power generator,
in response to power supply to the first electronic control unit being interrupted due to a failure in the first power supply, receiving the second driving voltage to generate a first auxiliary voltage, and supplying the first auxiliary voltage to the first electronic control unit whose power supply is interrupted, and
in response to power supply to the second electronic control unit being interrupted due to a failure in the second power supply, receiving the first driving voltage to generate a second auxiliary voltage, and supplying the second auxiliary voltage to the second electronic control unit whose power supply is interrupted.
